(19) United States
(12) Patent Application Publication
(10) Pub. No.: US 2002/0012839 A1
(43) Pub. Date: Jan. 31, 2002

(54) Electrolyte solution, a method for making such electrolyte solution and lead-acid batteries using such electrolyte solution

(75) Inventors: Paola Cavazos Jimenez, Monterrey (MX); Ricardo Flores Lira, Monterrey (MX)

Correspondence Address: Harrison and Egbert, 7th Floor, 412 Main Street, Houston, TX, 77002, US

(73) Assignee: ENERTEC, S. DE R.L. DE C.V.

(21) Appl. No.: 09/880,685

(22) Filed: Jun. 13, 2001

Related U.S. Application Data
(63) Continuation-in-part of application No. 09/359,626, filed on Jul. 22, 1999.

(51) Int. Cl. H01M 10/08

(52) U.S. Cl. 429/204; 429/52

(57) ABSTRACT

An electrolyte solution which increases the service life and charge acceptance of lead-acid batteries. The electrolyte solution includes an aqueous solution of sulfuric acid and boric acid. The boric acid has a concentration from about 2.5 grams per liter to less than 5.0 grams per liter of the aqueous solution of sulfuric acid. This electrolyte solution is used as a method of improving the service life and charge acceptance of lead-acid batteries.

### CROSS REFERENCE TO RELATED APPLICATIONS

The present application is a continuation-in-part of U.S. patent application Ser. No. 09/359,626, filed on Jul. 22, 1999, and entitled “ELECTROLYTE SOLUTION, A METHOD FOR MAKING SUCH ELECTROLYTE SOLUTION AND LEAD-ACID BATTERIES USING SUCH ELECTROLYTE SOLUTION”, presently pending.

### BACKGROUND OF THE INVENTION

1. Field of the Invention

The present invention relates to an electrolyte used in lead-acid batteries, to a method for using the electrolyte and to the batteries using such electrolyte. The electrolyte of the present invention enhances the battery service life and improves the charging and discharging characteristics of the batteries.

2. Definitions

For the purposes of clarity and conformity in the specification and the claims, the following terms will be defined according to SAE Recommended Practices.

The “Life Test” simulates automotive service where the battery operates in a voltage regulated charging system. It subjects the battery to charge and discharge cycles resulting in failure modes comparable to those encountered in automotive service.

The “Charge Rate Acceptance” is the ability of a new, previously untested wet battery (or activated dry charged battery) to accept a charge under conditions existing in the voltage-regulated electrical system of a vehicle at −1.1° C. with the battery in a partially discharged condition.

The “Reserve Capacity” is defined as the time of discharge in minutes. The fully charged battery at a temperature of 27±3° C. is discharged at 25±0.25 A to a terminal voltage equivalent to 1.75 V per cell measured under load.

The “Cold Cranking Test” is a measure of the cranking capability of a battery at the rating temperature.

The “Formation” is the electrochemical processing of a battery plate or electrode which transforms the active materials into their usable form. Charging the battery electrochemically changes the lead oxide paste on the plate grids to lead peroxide for the positive plates and to metallic lead for the negative plates.

The “Depolarization” is the reduction of polarization, usually in electrolytes. It may refer to removal of gas collected at plates of cell during charge or discharge.

3. Description of Related Art

Over the years, the basic construction of the lead-acid battery and its constituent cells remain essentially unchanged. Lead-acid batteries are made by serial connection of a plurality of cells wherein porous lead oxide is the active mass on the positive plate and spongy, porous lead is the active mass on the negative plate, and dilute sulfuric acid is the electrolyte of choice.

The charge/discharge mechanism of lead-acid batteries is known as the “double-sulfate” reaction. During discharge, both the metallic lead of the negative electrode and the lead dioxide of the positive electrode are converted to lead sulfate. The reverse process occurs during battery charging, namely, lead sulfate is converted to metallic lead at the negative electrode and to lead dioxide at the positive electrode.

Two of the most important performance parameters of lead-acid batteries are their service life and their charge and discharge characteristics. Both parameters depend on the manufacturing process of the batteries, on user characteristics and on the environment where they operate.

Lead-acid battery manufacturers are continuously searching for new improvements that can raise the performance of the battery, particularly at extreme temperatures. For example, cold climates can lower the capacity of the batteries, by raising the viscosity of the electrolyte and consequently lowering the rate of ion diffusion into the plates. On the other hand, in hot climates, the positive grid corrosion, the shedding of the positive active material and the contraction of the negative active material are the major causes of shortening service life of batteries.

A variety of components in the lead-acid batteries are exposed to a sulfuric acid environment, in particular, the positive and negative electrodes taking the form of grids. Due to the nature of this environment, one of the main battery failure modes is corrosion. During corrosion, the lead electrodes react with the acidic electrolyte and are converted into lead oxides. As more reaction products form, the resultant stress in the oxide layers produce an irreversible mechanical distortion of the battery grid, termed “grid creep”, resulting in separation of the active material.

Different solutions have been proposed to alleviate the problem of “grid creep” in lead-acid batteries. One technique involves alloying the lead grids with various elements to add strength through formation of a second phase, within a lead matrix. The design of the grids itself can also enhance battery life by promoting uniform mechanical expansion during corrosion. Increasing the thickness of the battery grids also increases their resistance to mechanical distortion. However these prior art approaches to grid design merely minimize the effects of “grid creep”. They do not deal with the fundamental problem of grid corrosion.

In U.S. Pat. No. 5,143,806 to Bullock et al., the problem of lead-acid battery grid corrosion is addressed through the formation of a protective layer of barium metaplumbate on the lead battery grid. Although barium metaplumbate resists attack by sulfuric acid, barium metaplumbate does decompose over time to form barium sulfate and lead dioxide in the presence of sulfuric acid.

Another solution to the problem of grid corrosion is proposed in U.S. Pat. No. 5,126,218 to Clarke. Clarke proposes making the entire grid of a conductive ceramic material, such as sub-stoichiometric titanium oxide. Although such grids do not corrode or degrade in sulfuric acid, they are difficult to fabricate and use because of the brittle nature of the ceramic material. U.S. Pat. No. 5,525,029 to Fiorino et al. provides a process for forming a titanium suboxide-containing coating on a lead alloy grid substrate to overcome the problems associated with the Clarke patent.

Few attempts have been made to improve the performance of a lead-acid storage battery by enhancement or modification of the electrolyte solution. In U.S. Pat No. 4,617,244 to Greene, it was suggested that the use of mixtures of metal salts or chelants of iron and magnesium could effectively increase the flow of current through the electrolyte solution to improve battery performance. However, the use of such additives can cause premature loss of battery activity. U.S. Pat. No. 5,582,934 to Steinbrecher provides electrolytic solutions including organic cathodic inhibitors for improving the performance of lead-acid storage batteries, and reducing corrosion in their lead components.

Phosphoric acid and the various phosphates have been used to improve the performance of the positive electrode of the battery. However, adverse effects of phosphoric acid have been observed. Adverse effects include capacity loss in the initial cycles, excessive mossing at high H₃PO₄ concentrations, and poor low-temperature performance.

The effect of boric acid as an electrolyte additive for sulfuric acid solutions using different electrochemical techniques has also been investigated. The results have shown that the boric acid can be used as an additive to improve the performance of the positive electrode of the lead-acid battery. However the mechanism by which the addition of the boric acid could enhance battery performance is unclear. On the other hand, it has been reported that mixed additives of H₃BO₃ and H₃PO₄ indicated corrosion inhibition of negative plates (Publication) and corrosion accelerated of positive plates (PbO₂).

In order to elucidate some contradictions of previous laboratory research and to determine the optimum conditions to increase the service life of lead-acid batteries, an extensive research program on electrolyte additives was carried out. The research led to the development of the present invention. The effect of several parameters on the service life of actual production lead-acid batteries under extreme conditions was studied. The parameters considered were the type and concentration of electrolyte additive, and the method of additive addition. The performance parameters of actual production lead-acid batteries evaluated in this research work were life cycle, reserve capacity, cold cranking capacity, and charge acceptance. All these tests were performed according to the Battery Council International (BCI) Standards. The results of these tests were confirmed by field tests in airport taxis and in city taxis.

As a result of the experimental work undertaken, it was found that boric acid additions to diluted aqueous solutions of sulfuric acid provided longer service life for lead-acid batteries. Surprisingly, it was discovered that the optimum service life of lead-acid batteries are reached within a narrow concentration of boric acid. It is accordingly an object of the present invention to provide an electrolyte, a method to use such electrolyte and a lead-acid battery using such electrolyte for improving the service life of batteries.

### BRIEF SUMMARY OF THE INVENTION

The present invention relates to an electrolyte for lead-acid batteries and to a lead-acid battery using the electrolyte. In accordance with the present invention, it has been discovered that careful control of boric acid content in a sulfuric acid solution can improve the service life and charge acceptance of lead-acid batteries. Further, and consistent with the selected boric acid level, it has been found that boric acid concentrations of between 2.5 grams per liter and less than 5.0 grams per liter are suitable for optimum high positive grid corrosion resistance and consequently maximum improvement of lead-acid battery service life and charge acceptance. Below and above these boric acid concentrations, the service life and charge acceptance of lead-acid batteries decreases.

Another aspect of the invention relates to a method for improving the performance characteristics of a lead-acid batteries, including decreasing the corrosion that occurs in the battery plate grids. This method includes the steps of assembling the positive and negative plate grids in an appropriate battery housing. The battery is then filled with a sulfuric acid solution and boric acid as additive at concentration within the range of about 2.5 grams per liter to less than 5.0 grams per liter of said sulfuric acid solution. After filling up the battery housing with the electrolyte solution, the battery is electrochemically formed so as to be ready for service.

In another preferred embodiment of the method of the present invention, after the negative and positive plate grids are assembled in a proper housing, a sulfuric acid solution is added to the housing. Then the battery is formed electrochemically before emptying out the sulfuric acid solution from the battery housing. Once empty, the battery housing is refilled with a new electrolyte solution having a sulfuric acid solution and boric acid as additive at concentrations within the range of about 2.5 grams per liter to less than 5.0 grams per liter of the sulfuric acid solution. The battery is then ready for service.

### BRIEF DESCRIPTION OF THE SEVERAL VIEWS OF THE DRAWINGS

FIG. 1 is a graph of Life Cycle Testing, according to SAE J240 Standard at 40° C., showing the influence of boric acid (5.25 grams/liter) as electrolyte additive upon life cycle effect of a lead-acid battery.

_______ Without boric acid

_______ With boric acid

FIG. 2 is a graph of Life Cycle Testing, according to SAE J240 modified method at 75° C., showing the influence of boric acid (5.25 grams/liter) as electrolyte additive upon life cycle effect of a lead-acid battery.

______ Without boric acid

______ With boric acid

FIG. 3 is a flow diagram showing the main steps of a method for using boric acid as electrolyte additive in lead-acid batteries according to the present invention.

FIG. 4 is a flow diagram showing the main steps of other alternative method for using boric acid as electrolyte additive in lead-acid batteries according to the present invention.

### DETAILED DESCRIPTION OF THE INVENTION

The present invention provides an electrolyte for lead acid batteries, in which the electrolyte comprises an aqueous solution of sulphuric acid and contains boric acid as additive, characterized in that the electrolyte includes 2.5 to less than 5.0 grams per liter of boric acid.

The invention also provides lead acid batteries including the above-defined electrolyte.

It was discovered that adding boric acid in the range of 2.5 to less than 5.0 grams per liter to a sulfuric acid solution, the service life and charge acceptance of lead acid batteries improves. The advantages which result from applying this invention can be seen by examining the test results which appear in the following Table:

TABLE I

| | | | | | | Sulfuric |
|---|---|---|---|---|---|---|
| Electrolyte | Sulfuric-Boric Acid | | | | | Acid |
| Boric Acid | 2.625 | 3.937 | 4.9 | 5.25 | 7.875 | |
| Concentration | | | | | | |
| (g/liter) | | | | | | |
| Weight (Kg) | 15, 34 | 14, 97 | 15, 17 | 15, 25 | 15, 1 | 15, 3 |
| Charge | 7, 8 | 23, 0 | 19, 41 | 17, 7 | 6, 8 | 7, 8 |
| Acceptance | | | | | | |
| (Amp) | | | | | | |
| 1st Reserve | 72, 0 | 102, 3 | 102, 6 | 102, 7 | 105, 3 | 70, 0 |
| Capacity (Min) | | | | | | |
| 2nd Reserve | 75, 0 | 97, 5 | 98 | 98, 1 | 81 | 83, 3 |
| Capacity (Min) | | | | | | |
| 3rd Reserve | 82, 0 | 99, 4 | 100 | 100, 1 | 75, 6 | 83, 2 |
| Capacity (Min) | | | | | | |
| 1st Cold | 7, 4 | 8, 2 | 8, 3 | 8, 3 | 7, 2 | 7, 6 |
| Cranking | | | | | | |
| (Voltage @ | | | | | | |
| 30 sec) | | | | | | |
| 2nd Cold | 7, 2 | 8, 0 | 8, 0 | 7, 9 | 6, 8 | 7, 4 |
| Cranking | | | | | | |
| (Voltage @ | | | | | | |
| 30 sec) | | | | | | |
| SAE J-240 | 4719 | 5148 | 7066 | 7722 | 3003 | 5363 |
| 40° C. | | | | | | |
| Life Cycles | | | | | | |
| SAE J-240 | | | | 7078 | | 3217 |
| 75° C. | | | | | | |
| Life Cycles | | | | | | |

The tests were performed according to the Battery Council International (BCI). It can be seen from this Table that the optimum charge acceptance is when the boric acid concentration is in the amount of 3.937 grams/liter. Higher boric acid concentrations, decrease the charge acceptance. When the boric acid is in a concentration of 7.875 grams/liter or higher, charge acceptance rapidly decreases. Although service life is at its greatest when the boric acid concentration is 5.25 grams/liter, it appears that the best compromise between charge acceptance, reserve capacity and life service tests is obtained under the conditions of boric acid concentrations within the range of 3.937 and 4.9 grams per liter. Our experimental work has indicated that at concentrations below 2.5 grams per liter and above 8.0 grams per liter of boric acid, positive grid corrosion will proceed at an appreciable rate.

The advantages of the present invention are further illustrated in the following test examples.

### EXAMPLE 1

The following table presents field tests in airport taxis and in city taxis.

TABLE II

| Battery Group | Days (Average) | Km (Average) |
|---|---|---|
| With Boric Acid | 500 (7 taxis) | 150,544 |
| Without boric acid | 325 (30 taxis) | 135,941 |

The results of these field tests confirmed the laboratory findings regarding the effect of boric acid on the lead-acid batteries life cycle. It is important to note that the battery group using boric acid as an electrolyte additive in lead-acid batteries are all still running after 500 days, while the others failed at an average of 325 days.

### EXAMPLE 2

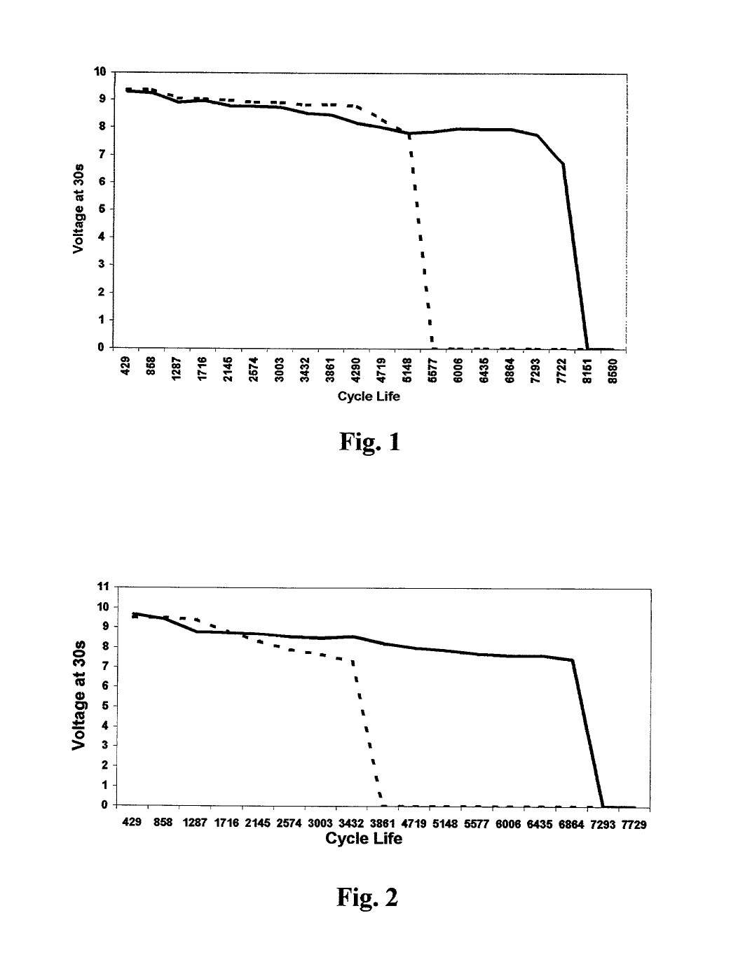

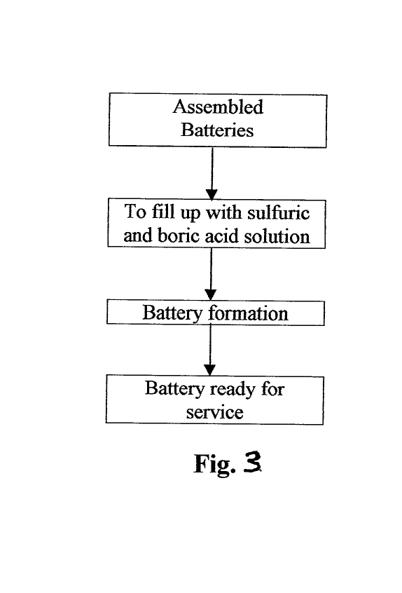

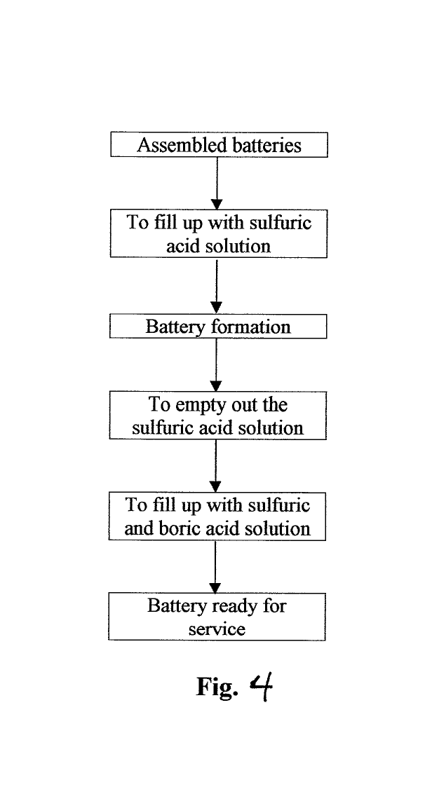

Referring now to FIG. 1 and FIG. 2, there are shown curves showing typical measurements of voltage versus life cycle at 40° C. and 75° C. respectively. These results shown life cycles of 7722 at 40° C. and 7078 at 75° C. for lead-acid batteries using boric acid as an electrolyte additive. The batteries having only sulfuric acid solutions as electrolyte show lower life cycles (3200 at 40° C. and 5300 at 75° C.).

It was found that the boric acid, used as an electrolyte additive for improving the service life of lead-acid batteries, reduces the positive plate grids corrosion by the depolarization of positive grid plates. Experiments have shown very poor positive grid plate integrity at 5363 life cycles when only an aqueous sulfuric acid solution is used as the electrolyte for lead-acid batteries. A good integrity of the grid plates results at 7722 life-cycles when boric acid in a concentration of 5.25 grams per liter is used as the electrolyte acid for the lead-acid batteries.

Another aspect of the invention relates to a method for improving the performance characteristics of a lead-acid batteries, including decreasing the corrosion that occurs in the battery grid plates. This method includes the steps of assembling the positive and negative plate grids in an appropriate battery housing. The battery is then filled with a sulfuric acid solution and boric acid as additive at concentration within the range of about 2.5 grams per liter to less than 5.0 grams per liter of the sulfuric acid solution. After filling up the battery housing with the electrolyte solution, the battery is electrochemically formed so as to be ready for service.

In another preferred embodiment of the method of the present invention, after the negative and positive plate grids are assembled in a proper housing, a sulfuric acid solution is added to the housing. Then the battery is formed electrochemically before emptying out the sulfuric acid solution from the battery housing. Once empty, the battery housing is refilled with a new electrolyte solution having a sulfuric acid solution and boric acid as additive at concentration within the range of about 2.5 grams per liter to less than 5.0 grams per liter of the sulfuric acid solution. The battery is then ready for service.

We claim:

1. An electrolyte solution to increase service life and charge acceptance of lead-acid batteries, the electrolyte solution comprising:
an aqueous solution of sulfuric acid; and
boric acid from about 2.5 grams per liter to less than 5.0 grams per liter of said aqueous solution of sulfuric acid.

2. A method of improving service life and charge acceptance of lead-acid batteries comprising:
assembling positive and negative plate grids in a battery housing;
filling said battery housing with an electrolyte which comprises an aqueous solution of sulfuric acid and boric acid, wherein said boric acid has a concentration of between 2.5 grams per liter and less than 5.0 grams per liter of said solution of sulfuric acid; and
forming electrochemically the batteries.

3. A method of improving service life and charge acceptance of lead-acid batteries comprising:
assembling positive and negative plate grids in a battery housing;
filling said battery housing with an electrolyte which is an aqueous solution of sulfuric acid;
forming electrochemically the batteries;
emptying the solution of sulfuric acid; and
refilling said battery housing with an electrolyte which comprises an aqueous solution of sulfuric acid and boric acid, wherein the boric acid has a concentration of between 2.5 grams per liter and less than 5 grams per liter of said solution of sulfuric acid.

4. A lead-acid battery comprising an electrolyte consisting essentially of an aqueous solution of sulfuric acid and boric acid in a concentration of between 2.5 grams per liter to less than 5.0 grams per liter of boric acid in said sulfuric acid solution.
